(19) United States
(12) Patent Application Publication
(10) Pub. No.: US 2012/0092685 A1
(43) Pub. Date: Apr. 19, 2012

(54) PRINTED FLIPBOOK SYSTEMS AND METHODS

(76) Inventor: Meredith Goldia Barrett, Long Branch, NJ (US)

(21) Appl. No.: 13/272,803

(22) Filed: Oct. 13, 2011

Related U.S. Application Data
(60) Provisional application No. 61/392,936, filed on Oct. 13, 2010.

(51) Int. Cl. G06F 15/00

(52) U.S. Cl. 358/1.6

(57) ABSTRACT

Systems and methods for creating a printed flipbook including a plurality of bound pages are disclosed. The system can include a camera, a printer configured to sequentially print images on a roll of cardstock, and an electronic media storage device having a control program stored thereon. The electronic media storage device can be configured to obtain a predetermined number of chronologically arranged images from the camera and send the obtained predetermined number of chronologically arranged images to a printer. The printer can be configured to sequentially print the chronologically arranged images on the roll of cardstock in series along a length thereof thereby sequentially creating the plurality of pages of the flipbook.

### CROSS REFERENCE TO RELATED APPLICATION

The present application claims the benefit from earlier filed U.S. Provisional Patent Application No. 61/392,936 filed Oct. 13, 2010, which is incorporated herein in its entirety by reference.

### FIELD OF THE INVENTION

The present teachings relate to systems and methods for efficiently creating printed flipbooks.

### BACKGROUND OF THE INVENTION

Systems and processes are known for making paper-based animated flipbooks for use at parties, business meetings, and other gatherings or events. However, known ways of making printed flipbooks involves the use of large, heavy, and difficult to use business card slitters for cutting to size the pages of the flipbooks, as well as various other disadvantages.

For example, U.S. Pat. No. 7,812,998 to Miers discloses a method of making a flipbook by printing on standard-sized 8.5×11 inch card stock and then cutting the paper using a business card slitter. Since business card slitters are not designed to keep the cut cards in a particular order, the cards can readily fly out of the slitter in a jumbled ordered. This then requires the additional tedious step of physically placing the cards back in proper order so that video action can be properly viewed when the cards of the flipbook are flipped.

Moreover, business card slitters are prone to miss-feeds and jamming which can also result in the re-ordering of the cards of the flipbook. This is especially true when 8.5 by 11 inch cardstock is run through the slitter as such a relatively large piece of paper is difficult and tricky to control during cutting.

Furthermore, in the method disclosed in Miers the slitter cuts off the sides of each sheet when creating the pages of the flipbook. In doing so, the slitter creates little slices of paper that have to be constantly cleaned up and disposed of. As a result, such known paper flipbook producing methods and systems can waste an enormous amount of paper. For example, a one-day event can produce a 30-gallon trash bag of waste paper.

For another example, U.S. Pat. No. 7,426,058 to Suzuki et al. discloses an image processing apparatus that controls the printing of a plurality of sequential still images. Suzuki et al. discloses printing the sequential still images on standard-sized 8.5×11 inch card stock which has been previously perforated. However, manually separating each page along the perforations is extremely tedious and time-consuming. In addition, keeping each page in proper order as they are manually separated also requires time and energy.

Accordingly, there exists a need for systems and methods for very efficiently creating printed flipbooks that require no special training to use, reduce or eliminate paper waste, are relatively small to transport, and are quiet in operation.

### SUMMARY OF THE INVENTION

The present teachings provide a system for creating a flipbook including a plurality of bound pages. The system can include a camera, a printer configured to sequentially print images on a roll of cardstock, and an electronic media storage device. The storage device can have a control program stored thereon configured to obtain a predetermined number of chronologically arranged images from the camera and send the obtained predetermined number of chronologically arranged images to a printer. The printer can be configured to sequentially print the chronologically arranged images on the roll of cardstock in series along a length thereof thereby sequentially creating the plurality of pages of the flipbook.

The present teachings also provide a method of creating a flipbook including a plurality of bound pages. The method can include providing a camera, providing an electronic media storage device with software stored thereon, and operating the camera for a period of time to obtain a sequence of recorded image data corresponding to a recorded event. The method can further include using the software to obtain a predetermined number of images from the sequence of recorded image data and sending the obtained predetermined number of chronologically arranged images to a printer. The method can still further include sequentially printing the chronologically arranged images on a roll of cardstock in series along a length of the cardstock to create the plurality of pages of the flipbook.

The present teachings still further provide a system for creating a flipbook including a plurality of bound pages. The system can include a camera, a printer, a cutting mechanism, and means for obtaining a predetermined number of chronologically arranged images from the camera and sending the images to the printer. The printer can be configured to sequentially print the chronologically arranged images on the roll of cardstock in series along a length thereof. The cutting mechanism can be configured to cut the roll of cardstock at a predetermined length after each image is printed to create each page of the flipbook

Additional features and advantages of various embodiments will be set forth, in part, in the description that follows, and will, in part, be apparent from the description, or may be learned by the practice of various embodiments. The objectives and other advantages of various embodiments will be realized and attained by means of the elements and combinations particularly pointed out in the description herein.

### BRIEF DESCRIPTION OF THE DRAWINGS

FIG. 1 shows the components of the system and method for creating printed flipbooks according to the present teachings;

FIG. 2 shows a stack of flipbook pages created using the system and method of FIG. 1 being covered by an optional front and back cover according to various embodiments;

FIG. 3 shows a stack of flipbook pages created using the system and method of FIG. 1 bound together using a mechanical binding mechanism according to various embodiments; and

FIG. 4 shows a printed flipbook created using the system and method of FIG. 1 being used by a user who is sequentially flipping the pages.

It is to be understood that both the foregoing general description and the following detailed description are exemplary and explanatory only, and are intended to provide an explanation of various embodiments of the present teachings.

### DETAILED DESCRIPTION OF THE PREFERRED EMBODIMENTS

The present teachings relate to systems and methods for readily converting live or pre-recorded video or digital images into printed flipbooks. As used herein, the term flipbook refers to a stack of at least two pages, bound at or near one edge of the stack, with each page containing one book image. The images on each successive page of the flipbook are slightly altered from the previous image so as to simulate motion as the pages are sequentially flipped.

The systems and methods of the present teachings allow for the very efficient production of printed flipbooks at live events while customers are waiting. It presents an inexperienced individual the ability to readily step-in and produce flipbooks through the use of a copier that can print on rolls of cardstock. The printed-on cardstock can be sequentially cut into the pages making-up the flipbook in a clean and paper-saving manner so as to reduce or eliminate waste.

The systems and methods of the present teachings can include a video capture system and flipbook creating software that can run on a host processing system that can convert sequentially captured video or digital images into separately viewable images.

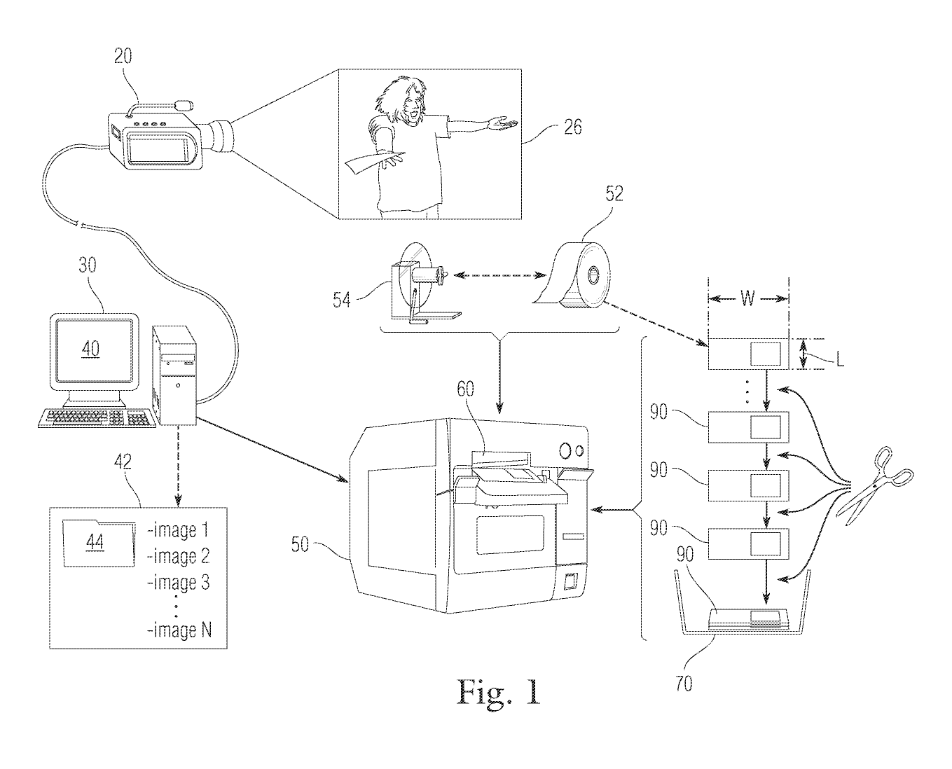

Referring to FIG. 1, to create a printed flipbook according to the present teachings, an image sequence can be recorded using an analog or digital video capture device 20. The video capture device 20 can be a camera, such as a video camera, high-speed digital camera, web cam, stop-action camera, mobile-phone camera, and the like. For example, to begin the process of creating a flipbook a party guest or host can be invited into a mobile video studio 26 which includes the video capture device 20. Within the mobile video studio 26, the guest or host performs a short skit which is videotaped for a short period of time, such as, for example, 7 seconds.

The video capture device 20 can allow the user to capture video at user-defined frame rates. The preferred frame rate can be 30 frames per second, but can vary from 5 frames per second to 50 frames per second. The preferred time interval for recording video footage according to the present invention is about 7 seconds, but could be any time interval depending on the desired size or running time of the flipbook to be created.

When electronic image recording is complete, the image data can be stored on a computer 30 in an appropriate video file format (e.g., avi, MPEG, QuickTime, or any future type of image format). For example, the image data can be stored on a local computer 30 as shown in FIG. 1. The local computer 30 can be the host processing system. Throughout this patent application, the storage of image data and software can be achieved by way of one or more of; a hard drive on an individual computer, an external hard drive, a server hard drive, a web server, a CD, a DVD, in flash memory, a flash drive, a web folder, or any other known electronic media storage device or system.

The recorded image data can then be parsed into separate stills which are then saved as separate image files. The separate images can be parsed and generated by using the flipbook creating software 40 that can run on the host processing system, such as the local computer 30 as shown in FIG. 1. Each of these images can be stored on the local computer hard drive as a separate image file (e.g., JPEG, BMP, GIF, TIF, or any future type of image format). During electronic image recording and the image selection process, the separate stills created for each flipbook can be saved in a uniquely identified folder 44 on the local computer using a “book number” identifier.

More particularly, the flipbook creating software selectively parses a predetermined number of separate images from the recorded image data, such as, for example, 60 images. The software can selectively capture the images from the recorded image data by equally selecting images to obtain the desired predetermined number of images for the flipbook. As will be discussed below, these separate images can be printed as separate pages that can be stacked to create the flipbook. While a preferred embodiment of the present teaching creates a flipbook including 60 pages, it is understood that the present teachings can be used to create flipbooks having as few as 2 pages and as many as 120 pages or more.

For example, if a user-defined record rate is set at the preferred time interval of 7 seconds at the preferred frame rate of 30 frames per second, then 210 frames are created and the software will select one frame for every 3 or 4 frames using a 2:3 pulldown technique. The 2:3 pulldown technique would be known to one of ordinary skill in the art. As a result, 60 images are selected and saved in the folder 44 with the images being dispersed approximately evenly over the 7 second time interval of the recorded image data.

For another example, if a user-defined record rate is set at the preferred time interval of 7 seconds at a frame rate of 60 frames per second, then 420 frames are created and the software will select one frame for every 7 frames. As in the first example, 60 resulting images are selected and saved and are dispersed approximately evenly over the 7 second time interval of the recorded image data.

As such, each separate image file or still represents a portion of the recorded image data at an instant of time within a particular time interval. According to a preferred embodiment, the flipbook creating software can produce 60 separate JPEG image files which can be stored in the uniquely identified book folder 44 using the “book number” identifier. For example, each JPEG image file can be about 640 pixels by about 480 pixels (w×h). The book folder 44 can include a series of saved images that have been individually collated in a sequence corresponding to the order in which they were recorded. The saved images can be numbered starting from 1. For example, the numbering can be from 1 to 60 for a series of 60 images.

Unrelated to the system and method of making printed flipbooks of the present teachings, the flipbook creating software can also create a video file from the series of saved images (for example, 60 images). The video file can be a user-defined video file in a format that is also user-defined, such as, for example, MPEG-4, H.264, AVI, Quicktime or WMV. The video file can be created using codecs from FFMPEG.org which is free software licensed under the LGPL or GPL. The saved video file can be exported to another computer or device, or uploaded by FTP to a website for further use such as for the creation of an electronic flipbook.

The flipbook creating software 40 can take the series of images (image 1 through image N) that have been saved in the uniquely identified book folder 44 and send them to a printer 50 for printing. The printer 50 can be capable of printing images sequentially on card stock. More particularly, the printer can print the images on the cardstock in series along a length of the cardstock. For example, the printer 50 can be a label printer or a medical bracelet printer which can be fed with a roll of cardstock 52. The roll 52 of cardstock can be custom-made cardstock having a specific width, W, such as, for example, about 3.5 inches. A label unwinder 54 can be arranged to feed the roll of cardstock 52 into the printer 50. Alternatively, any other device or arrangement for feeding the cardstock 52 into the printer 50 can be implemented.

According to various embodiments, the present teachings can be used or accomplished with various types of printers 50, including ink jet, laser, flash, and other known printing methods and devices. In a preferred embodiment, the printer 50 can be the EPSON SecurColor™ inkjet printer (available from EPSON America, Inc., of Long Beach, Calif.).

The printer 50 can be fitted with a cutting device 60 at the exit of the printer 50. After an individual image is printed onto the cardstock using the printer 50, the printed cardstock can exit the printer 50 and can be cut at a specific length, L, to create an individual flipbook page. Alternatively, the cutting device 60 can be a mechanism that is separate and distinct from the printer 50.

According to a preferred embodiment, a roll of cardstock 52 having a width, W, of 3.5 inches is used which is then cut at 2 inch intervals, L, after an image has been printed on the section of cardstock. As a result, a 3.5 inch by 2 inch page is created. After being cut, each individual page 90 can be sequentially received in a receptacle 70 or any other type of receiving area. Accordingly, all of the separate pages 90 can be cut to a uniform size and shape, and then stacked. After all of the images of the book folder 44 are sequentially printed in series along the length of the roll of cardstock 52 and a stack of sequential pages are created, the stack can be removed from the receiving area 70 for further processing by the user.

According to various embodiments, the roll of cardstock 52 can be perforated at predetermined intervals so as to eliminate the need for any cutting. Instead of perforations, the cardstock can include any mechanism for readily separating the cardstock into pages along the length of the cardstock. For example, for a roll of cardstock 52 having a width, W, of 3.5 inches, perforations can be arranged at 2 inch intervals, along the length, L. After one or more images have been printed on the non-perforated sections of cardstock, the operator can create 3.5 inch by 2 inch pages by separating along the perforations, thereby not creating any waste.

According to a preferred embodiment, the flipbook creating software 40 sends the images to the printer 50 in an order whereby the chronologically last image file (e.g. image 60) can be printed and cut first. The flipbook creating software 40 then repeats the printing and cutting process for the remaining image files, sending another image file (e.g. image 59) to the printer for printing and subsequent cutting. The images can also be printed in a reverse chronological order, such as, for example, starting from image 1 and proceeding sequentially to image 60. According to various embodiments, the flipbook creating software 40 can send the images to the printer in a full batch (e.g. all 60 images) or in partial batch whereby the images can be stored in the printer's buffered memory while printing is performed in either a forward or reverse chronological order.

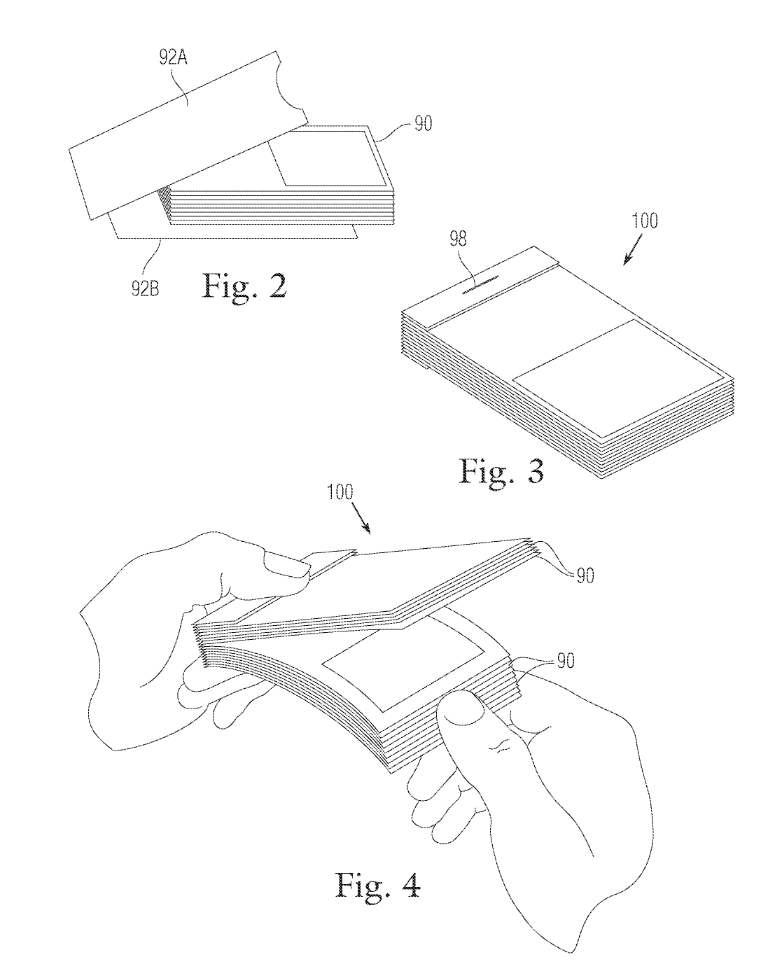

As shown in FIG. 2, a front cover 92A and/or a back cover 92B can be optionally placed over the top and bottom of the stack of pages 90 before a binding process is performed. As shown in FIG. 3, the final stack can be bound together near an edge of the pages opposite from the printed images using a mechanical binding mechanism 98 including a metal staple, a metal or plastic clip, rubber band, book perfect binding, or any other binding method known in the art. The final bound stack forms the printed flipbook 100.

As shown in FIG. 4, the bound pages 90 can then be individually ‘flipped’ in sequence to illustrate movement of the persons or characters that were initially electronically recorded.

The systems and methods of the present teachings allow the efficient creation of printed flipbooks at live events. This allows the guests of the event or anyone else using the system that has just been videotaped to receive their flipbook without having to wait a long period of time upon completion of videotaping. The present teachings also allow an inexperienced individual the ability to step-in and produce printed flipbooks with very little training. By incorporating a specialty printer that accepts a roll of cardstock, the systems and methods of the present teachings allows the pages of the flipbook to be cut in a clean and paper-saving manner. Also, the systems and methods of the present teachings are smaller and quieter than currently known printed flipbook creating systems.

According to various embodiments, the system and method of the present teachings can be implemented on a local computer, a local computer and a server, more than one computer, a combination of a local computer and a web server, on a mobile phone or smartphone having a camera feature, an FTP site, a photo-sharing site, or a combination thereof. When implemented on a mobile phone or smartphone, the flipbook system and method of the present teachings can be in the form of an “app” that can be downloaded onto the phone for use with the hardware of the phone and a printer as disclosed above.

Those skilled in the art can appreciate from the foregoing description that the present teachings can be implemented in a variety of forms. Therefore, while these teachings have been described in connection with particular embodiments and examples thereof, the true scope of the present teachings should not be so limited. Various changes and modifications may be made without departing from the scope of the teachings herein.

What is claimed is:

1. A system for creating a flipbook including a plurality of bound pages comprising:
a camera;
a printer configured to sequentially print images on a roll of cardstock;
an electronic media storage device, the storage device having a control program stored thereon configured to:
obtain a predetermined number of chronologically arranged images from the camera; and
send the obtained predetermined number of chronologically arranged images to a printer;
wherein the printer is configured to sequentially print the chronologically arranged images on the roll of cardstock in series along a length thereof thereby sequentially creating the plurality of pages of the flipbook.

2. The system of claim 1, further comprising a cutting mechanism configured to sequentially cut the roll of cardstock at a predetermined length after each image is printed.

3. The system of claim 2, further comprising a receiving area for collecting the sequentially created pages after each page is sequentially formed by the cutting mechanism.

4. The system of claim 2, further comprising a mechanical binding mechanism configured to bind the plurality of pages to form the flipbook.

5. The system of claim 1, wherein the control program is configured to obtain the predetermined number of images from the camera based upon a user-defined record rate.

6. The system of claim 1, further comprising a label unwinder configured to support the roll of cardstock as it is fed into the printer.

7. The system of claim 1, wherein the roll of cardstock includes a width of about 3 inches to about 4 inches.

8. The system of claim 7, further comprising a cutting mechanism configured to sequentially cut the roll of cardstock at a predetermined length of between about 1.5 inches and about 2.5 inches after each image is printed.

9. The system of claim 1, wherein the printer is a label printer.

10. The system of claim 1, wherein the system is adapted for use on a mobile phone having a camera.

11. A method of creating a flipbook including a plurality of bound pages comprising:
providing a camera;
providing an electronic media storage device with software stored thereon;
operating the camera for a period of time to obtain a sequence of recorded image data corresponding to a recorded event;
using the software to obtain a predetermined number of images from the sequence of recorded image data;
sending the obtained predetermined number of chronologically arranged images to a printer; and
sequentially printing the chronologically arranged images on a roll of cardstock in series along a length of the cardstock to create the plurality of pages of the flipbook.

12. The method of claim 11, further comprising sequentially cutting the roll of cardstock at a predetermined length after each image is printed in series on the roll of cardstock to create each page.

13. The method of claim 12, further comprising mechanical binding the plurality of pages to form the flipbook.

14. The method of claim 11, wherein obtaining the predetermined number of images from the camera is based upon a user-defined record rate.

15. The method of claim 11, further comprising using a label unwinder to support the roll of cardstock as the cardstock is fed into the printer.

16. The method of claim 11, wherein the roll of cardstock includes a width of about 3 inches to about 4 inches.

17. The method of claim 16, further comprising sequentially cutting the roll of cardstock at a predetermined length of between about 1.5 inches and about 2.5 inches after each image is printed in series on the roll of cardstock to create each page.

18. The method of claim 11, wherein the printer is a label printer.

19. The method of claim 10, wherein the method is performed using a mobile phone having a camera.

20. A system for creating a flipbook including a plurality of bound pages comprising:
a camera;
a printer;
a cutting mechanism; and
means for obtaining a predetermined number of chronologically arranged images from the camera and sending the images to the printer;
wherein the printer is configured to sequentially print the chronologically arranged images on the roll of cardstock in series along a length thereof; and
wherein the cutting mechanism is configured to cut the roll of cardstock at a predetermined length after each image is printed to create each page of the flipbook.
